(19) United States
(12) Patent Application Publication
(10) Pub. No.: US 2002/0087752 A1
(43) Pub. Date: Jul. 4, 2002

(54) Method of real time statistical collection for I/O controllers

(76) Inventors: Patrick L. Connor, Portland, OR (US); Patrick J. Luhmann, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/752,099

(22) Filed: Dec. 28, 2000

(51) Int. Cl. G06F 13/00; G06F 13/14; G06F 13/28

(52) U.S. Cl. 710/35

(57) ABSTRACT

A statistics reporting process includes a status information process for receiving status information concerning individual data packets. A statistics information process receives statistical information concerning various bus conditions. A unified write process stores the status information and the statistical information on a storage device using a single write procedure.

### TECHNICAL FIELD

This invention relates to packet information reporting.

### BACKGROUND

When network devices (e.g. network interface cards, routers, hubs, switches) receive packets of data, status information is available concerning the size and condition of the data packets received. Additionally, the network devices can provide statistical information concerning the functionality of the network devices and the network itself.

Typically, an I/O controller (embedded within the network device) receives the data packets and systematically writes them to a memory device using a device driver. To retrieve the statistical and status information, the device driver requests this information from the I/O controller, which interrupts operation of the I/O controller. The I/O controller writes the statistical information or the status information, one after the other in either order, to the memory device. The statistical information and the status information are then available for retrieval by the device driver. Each time the I/O controller writes either the statistical information or the status information, it takes control of the bus connecting the memory device and the I/O controller.

### DESCRIPTION OF DRAWINGS

FIGS. 1, 2, and 3 show real-time statistics reporting processes; and

FIG. 4 shows a real-time statistics reporting method.

### DETAILED DESCRIPTION

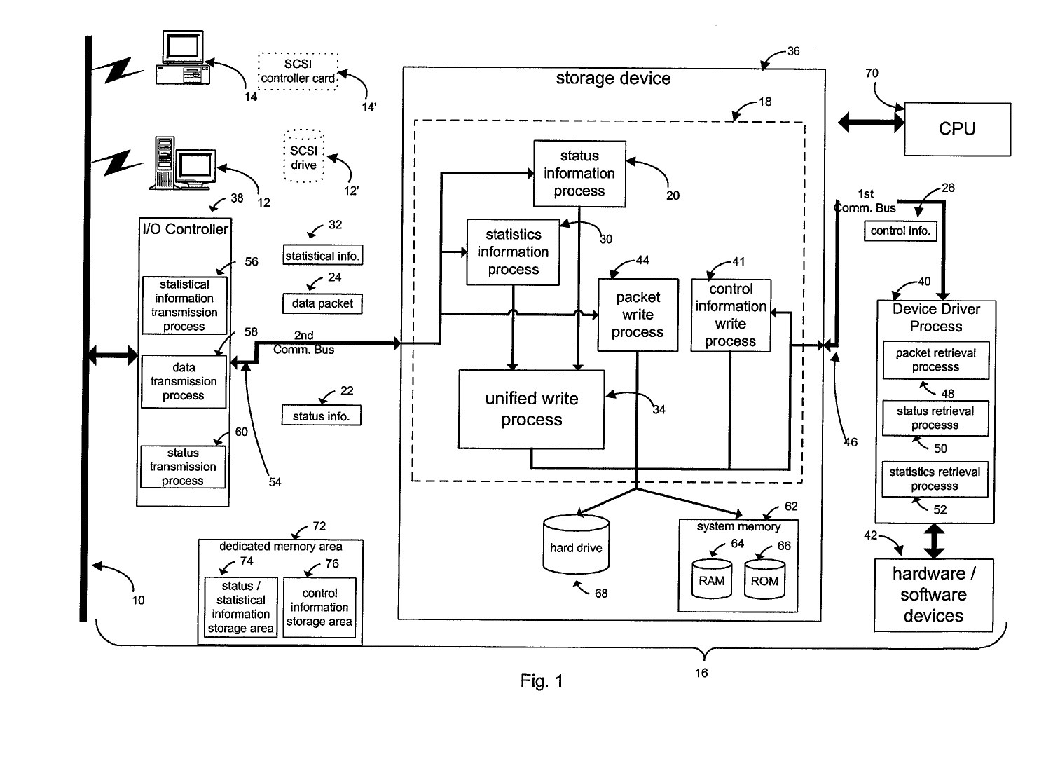

Referring to FIG. 1, a data bus 10 (e.g., in the form of a distributed computing network such as a local area network, intranet, extranet, Internet) transports data from source 12 (e.g., a network server) to destination 14 (e.g., a network client). Alternatively, data bus 10 may be a communication bus (e.g., SCSI, PCI, VESA, ISA, EISA) within a computing device, source 12 may be a device on the data bus 10 that transmits data (e.g., a SCSI hard drive 12′ (shown in phantom)), and destination 14 may be a device on data bus 10 that receives data (e.g., a SCSI controller card 14′ (shown in phantom)).

Another destination device 16 is shown in more detail. Embedded in and operating on destination device 16 is real-time statistics reporting process 18, which includes a status information process 20 for receiving status information 22 concerning the individual data packets 24 received from bus 10. Status information 22 specifies various details (e.g., packet size, packet length, packet type, packet checksum status, packet condition, ______, ______, ______, ______) concerning the individual data packets 24 received from data bus 10. A statistics information process 30 receives statistical information 32 from bus 10 concerning various bus conditions (e.g., late collisions, excess collisions, dropped frames, ______, ______, ______, ______).

Unified write process 34 stores both status information 22 and statistical information 32 on a storage device 36 using a single write procedure. By writing these two pieces of information 22 and 32 using a single write procedure, storage efficiency is increased, as unified write process 34 only has to gain control of the bus 54 that transfers information 22 and 32 to storage device 36 once.

Input/Output (I/O) controller 38 receives data packets 24, which were transmitted by source 12, from data bus 10. Additionally, I/O controller 38 monitors the status of data bus 10 and generates statistical information 32.

Device driver process 40 interfaces real-time statistics reporting process 18 and hardware/software devices 42. As stated above, destination device 16 is a device that receives data, in the form of packets 24, from data bus 10. Typical examples of destination devices 16 are network interface cards, routers, hubs, and switches. Accordingly, hardware/software devices 42 represent the hardware/software components of the above-referenced examples. Destination device 16 is typically a bi-directional communication device that sends packets as well as receiving them.

Device driver process 40 generates control information 26 and provides it to control information write process 41 of real-time statistics reporting process 18. This control information 26 specifies the address (i.e., packet location) within storage device 36 where the data packets 24 are to be stored.

Packet write process 44 stores each data packet 24 on storage device 36 at the location(s) specified by control information 26. Typically, one piece of control information 26 will specify multiple storage addresses (e.g., four) for multiple packets 24 of data. The specific addresses (not shown) incorporated into control information 26 are stored and queued on storage device 36. As the data packets 24 to be stored at these addresses are received by I/O controller 38, packet write process 44 stores these data packets 24 on storage device 36 at the addresses specified in control information 26.

A first communication bus 46, which interfaces device driver process 40 and real-time statistics reporting process 18, allows device driver process 40 to transmit control information 26 to control information write process 41.

Device driver process 40 includes a packet retrieval process 48, which retrieves data packets 24 stored on storage device 36 (by packet write process 44), so that these packets 24 can be provided to hardware/software devices 42. Device driver process 40 also includes a status retrieval process 50, which retrieves status information 22 stored on storage device 36 (by unified write process 34) so that this status information 22 can be provided to hardware/software devices 42. Device driver process 40 also includes a statistics retrieval process 52, which retrieves statistical information 32 stored on storage device 36 (by unified write process 34) so that this statistical information 32 can be provided to hardware/software devices 42. As device driver process 40 retrieves status information 22 and statistical information 32 directly from storage device 36, device driver process 40 does not have to interrupt I/O controller 38 to request these pieces of information 22 and 32.

Packet retrieval process 48, status retrieval process 50, and statistics retrieval process 52 utilize first communication bus 46 to communicate with real-time statistics reporting process 18. Typically, first communication bus 46 is a fast (e.g., 133-200 MHz) and wide (e.g., 256 bit) high-speed bus, such as a system bus.

A second communication bus 54 interfaces I/O controller 38 and real-time statistics reporting process 18. In I/O controller 38, a statistical information transmission process 56 transmits statistical information 32 to statistics information process 30. A data transmission process 58 transmits data packets 24 to packet write process 44. A status information process 60 monitors data packets 24 received by I/O controller 38, generates status information 22, and transmits it to status information process 20.

Statistical information transmission process 56, data transmission process 58, and status transmission process 60 utilize second communication bus 54 to communicate with real-time statistics reporting process 18. Typically, second communication bus 54 is a moderately-fast (e.g., 66 MHz) and moderately-wide (e.g., 64 bit) bus, such as a Peripheral Component Interconnect (PCI) bus.

During the operation of real-time statistics reporting process 18, device driver process 40 generates control information 26, which specifies one or more addresses where data packets 24 (not yet received) are going to be stored on storage device 36. This control information 26 is provided to control information write process 41, which stores control information 26 on storage device 36. When data packets 24 are received by I/O controller 38, data transmission process 58 provides these data packets 24 to packet write process 44. Packet write process 44 then stores data packets 24 on storage device 36 at the addresses specified in control information 26 stored on storage device 36.

For each data packet 24 received by I/O controller 38, I/O controller 38 generates a piece of status information 22 for that specific data packet 24. Status information 22 specifies various details (e.g., packet size, packet length, packet type, packet checksum status, packet condition, ______, ______, ______, ______) concerning the specific data packet received. Further, I/O controller 38 monitors bus 10 and generates statistical information 32 concerning various bus conditions (e.g., late collisions, excess collisions, dropped frames, ______, ______, ______, ______). While status information 22 is generated for each packet 24 received, statistical information 32 tends to be generated less frequently (e.g., every ______ mS). As stated above, unified write process 34 writes status information 22 and statistical information 32 to storage device 36 using a single write procedure. Accordingly, this single write procedure reduces the number of times that real-time statistics reporting process 18 has to gain control of second communication bus 54. However, as statistical information 32 is typically generated less frequently than status information 22, it is not always possible to write status information 22 and statistical information 32 using a single write procedure, as statistical information 32 may not be able each time status information 22 is available for writing.

Storage device 36 may be a system memory 62, including both random access memory (RAM) 64 and read only memory (ROM) 66. As ROM 66 is non-volatile memory, real-time statistics reporting process 18 may be incorporated into and stored on ROM 66 of system memory 62. As RAM 64 can be easily written and overwritten, status information 22, data packets 24, control information 26, and statistical information 32 are stored on RAM 64 of system memory 62. Storage device 36 may include a hard drive 68 for additional storage capacity. A central processing unit (CPU) 70, interfaced with storage device 36, executes real-time statistics reporting process 18 residing on storage device 36.

Storage device 36 includes a dedicated memory area 72 for storing status information 22, control information 26, and statistical information 32. Dedicated memory area 72 includes a status/statistical information storage area 74 and a control information storage area 76. As stated above, device driver process 40 generates control information 26, which is provided to control information write process 41 so that it can be written to storage device 36. This control information 26 is stored in control information storage area 76 of dedicated memory area 72. As data packets 24 are received by I/O controller 38, status information 22 (concerning the condition of the individual data packets) and statistical information 32 (concerning the condition of the bus itself: if available) are written, via unified write process 34, to storage device 36. These pieces of information 22 and 32 are stored in status/statistical information storage area 74 of dedicated memory area 72.

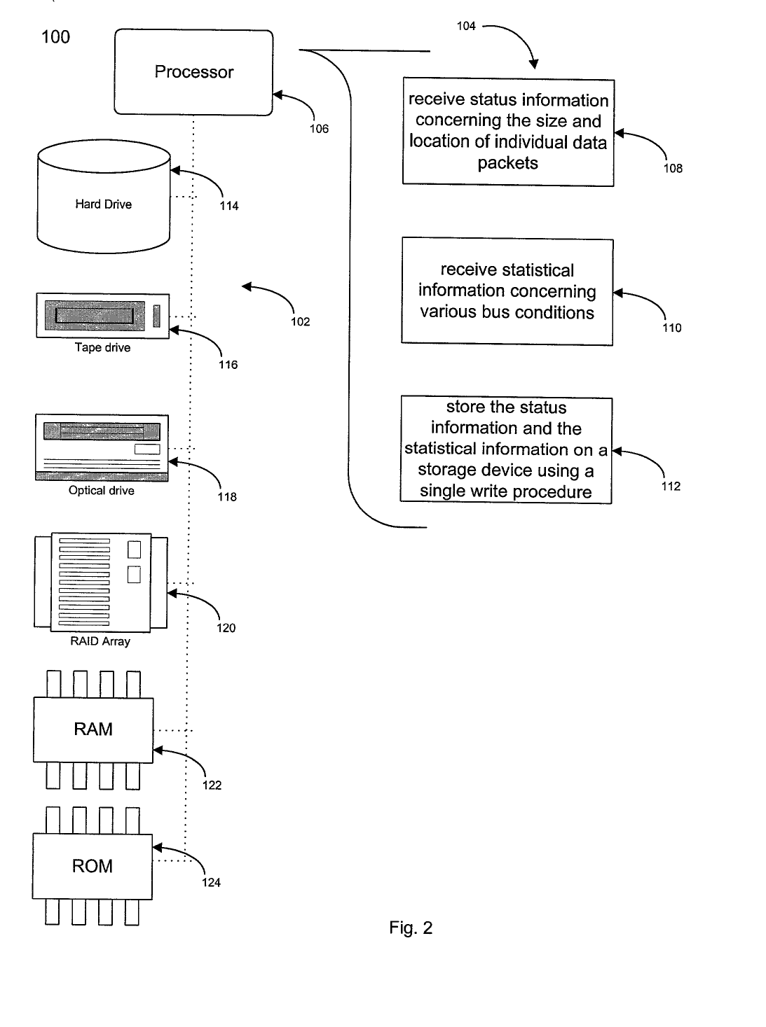

In FIG. 2, the instructions of a computer program product 100 stored on a computer readable medium 102 functions within a destination device on a communication bus. When executed by processor 106, instructions 104 cause processor 106 to receive 108 status information concerning the size and location of the individual data packets. Computer program product 100 receives 110 statistical information concerning various bus conditions and stores 112 the status information and the statistical information on a storage device using a single write procedure.

Typical embodiments of computer readable medium 102 are: hard drive 114; tape drive 116; optical drive 118; RAID array 120; random access memory 122; and read only memory 124.

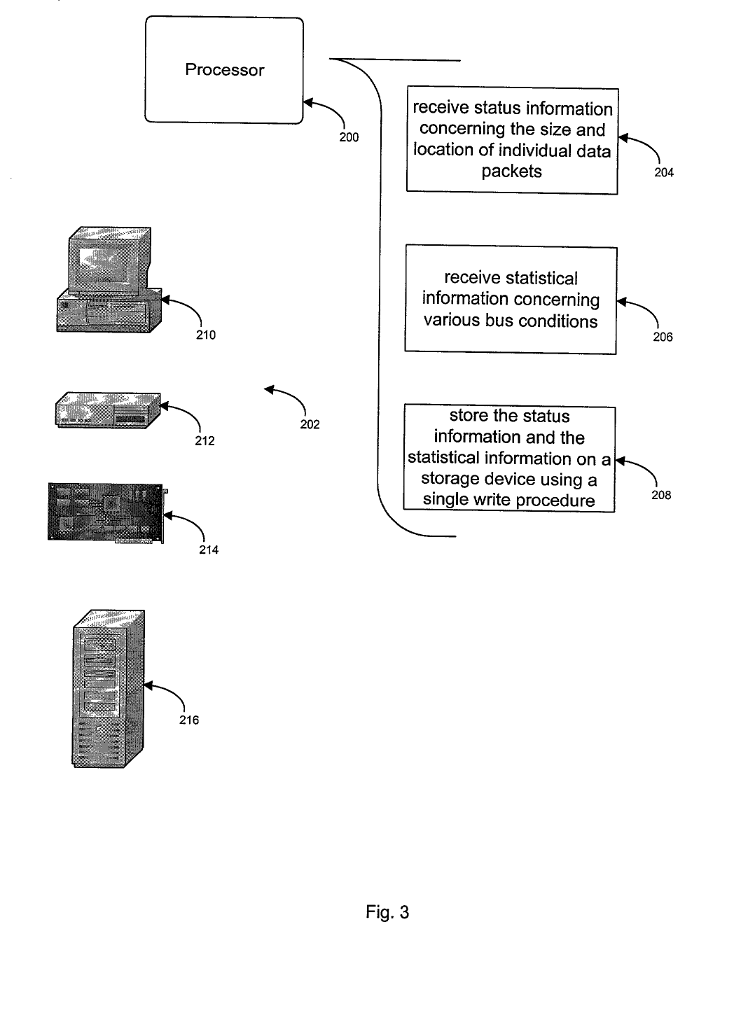

FIG. 3 shows a processor 200 and memory 202 configured to receive 204 status information concerning the size and location of the individual data packets. Processor 200 and memory 202 receive 206 statistical information concerning various bus conditions and store 208 the status information and the statistical information on a storage device using a single write procedure.

Processor 200 and memory 202 may be incorporated into a personal computer 210, a programmable logic controller 212, a single board computer 214, or a network server 216.

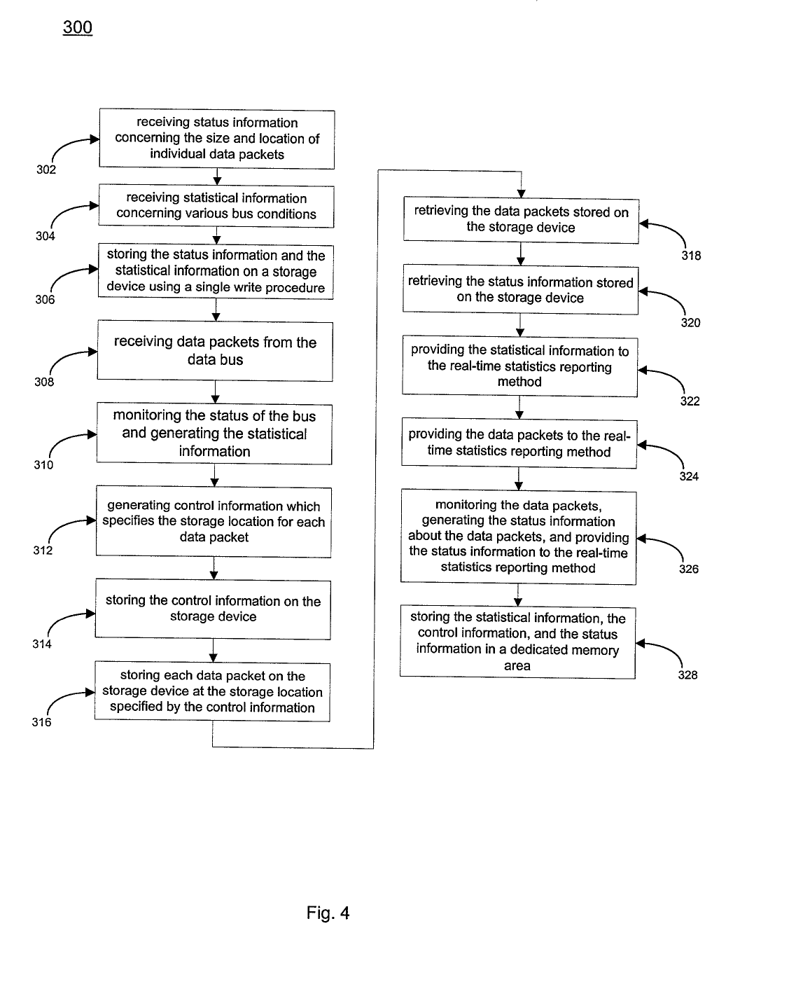

FIG. 4 shows a real-time statistics reporting method 300 in which a status information process receives 302 status information concerning the size and location of individual data packets. A statistics information process receives 304 statistical information concerning various bus conditions. A unified write process stores 306 the status information and the statistical information on a storage device using a single write procedure.

An I/O controller receives 308 the data packets from the data bus and monitors 310 the status of the bus and generates the statistical information. A device driver process generates 312 control information which specifies the storage location for each data packet. A control information write process stores 314 the control information on the storage device. A packet write process stores 316 each data packet on the storage device at the storage location specified by the control information. A packet retrieval process retrieves 318 the data packets stored on the storage device. A status retrieval process retrieves 320 the status information stored on the storage device. A statistical information transmission process provides 322 the statistical information to the real-time statistics reporting method. A data transmission process provides 324 the data packets to the real-time statistics reporting method. A status transmission process, which monitors the data packets and generates the status information about the data packets, provides 326 the status information to the real-time statistics reporting method. A unified write process stores 328 the statistical information, the control information, and the status information in a dedicated memory area.

Other embodiments are within the scope of the following claims.

What is claimed is:

1. A method comprising:
receiving status information concerning a size and location of a data packet;
receiving statistical information concerning a bus condition; and
storing the status information and the statistical information on a storage device using a single write procedure.

2. The method of claim 1 further comprising receiving the data packets from the data bus.

3. The method of claim 1 further comprising monitoring the status of the bus and generating the statistical information.

4. The method of claim 1 further comprising generating control information which specifies the storage location for each data packet.

5. The method of claim 4 further comprising storing the control information on the storage device.

6. The method of claim 5 further comprising storing each data packet on the storage device at the storage location specified by the control information.

7. The method of claim 5 further comprising retrieving the data packets stored on the storage device.

8. The method of claim 5 further comprising retrieving the status information stored on the storage device.

9. The method of claim 1 further comprising monitoring the data packets, generating the status information about the data packets, and providing the status information to the method.

10. A statistics reporting process comprising:
a status information process for receiving status information concerning a data packet;
a statistics information process for receiving statistical information concerning a bus condition; and
a unified write process for storing said status information and said statistical information on a storage device using a single write procedure.

11. The statistics reporting process of claim 10 further comprising an Input/Output (I/O) controller connected to a data bus; wherein said I/O controller receives from said data bus said data packets and said I/O controller monitors the status of said bus and generates said statistical information.

12. The statistics reporting process of claim 11 further comprising a control information write process for receiving control information which specifies a storage location where each said data packet is to be stored and storing said control information on said storage device.

13. The statistics reporting process of claim 12 further comprising a device driver process for generating said control information and providing it to said control information write process.

14. The statistics reporting process of claim 13 further comprising a packet write process for storing each said data packet on said storage device at said storage location specified by said control information.

15. The statistics reporting process of claim 14 further comprising:
a first communication bus for interfacing said device driver process and said statistics reporting process;
wherein said device driver process provides said control information to said control information write process via said first communication bus.

16. The statistics reporting process of claim 15 wherein said device driver process includes a packet retrieval process for retrieving said data packets stored on said storage device via said first communication bus.

17. The statistics reporting process of claim 15 wherein said device driver process includes a status retrieval process for retrieving said status information stored on said storage device via said first communication bus.

18. The statistics reporting process of claim 14 further comprising a second communication bus for interfacing said I/O controller and said statistics reporting process.

19. The statistics reporting process of claim 18 wherein said I/O controller includes a statistical information transmission process for providing said statistical information to said statistics information process via said second communication bus.

20. The statistics reporting process of claim 18 wherein said I/O controller includes a data transmission process for providing said data packets to said packet write process via said second communication bus.

21. The statistics reporting process of claim 18 wherein said I/O controller includes a status transmission process for monitoring said data packets, generating said status information concerning the size and condition of said data packets, and providing said status information to said status information process via said second communication bus.

22. The statistics reporting process of claim 10 wherein said storage device is a system memory.

23. The statistics reporting process of claim 22 wherein said system memory includes a Read Only Memory (ROM) and said statistics reporting process resides on said ROM.

24. The statistics reporting process of claim 10 wherein said storage device includes a dedicated memory area for storing said statistical information, said control information, and said status information.

25. The statistics reporting process of claim 24 wherein said dedicated memory area includes:
a control information storage area for contiguously storing said control information, and
a status/statistical information storage area for contiguously storing said status information and said statistical information;
wherein said unified write process stores said status information and said statistical information using a single write procedure.

26. A computer program product residing on a computer readable medium having a plurality of instructions stored thereon which, when executed by the processor, cause that processor to:
receive status information concerning the size and location of the individual data packets;
receive statistical information concerning various bus conditions; and
store the status information and the statistical information on a storage device using a single write procedure.

27. The computer program product of claim 26 wherein said computer readable medium is a read-only memory.

28. A statistics reporting system comprising:
an Input/Output (I/O) controller connected to a distributed computing network; wherein said I/O controller receives data packets from said network, monitors the status of said network and generates statistical information concerning said network's condition;
a statistics reporting process comprising:
a status information process for receiving status information concerning a data packet;
a statistics information process for receiving said statistical information; and
a unified write process for storing said status information and said statistical information on a storage device using a single write procedure; and
a central processing unit (CPU) for executing said statistics reporting process which resides on a Read Only Memory.

29. The statistics reporting system of claim 28 wherein said statistics reporting process further includes:
a control information write process for receiving control information which specifies a storage location where each said data packet is to be stored and storing said control information on said storage device; and
a device driver process for generating said control information and providing it to said control information write process.

30. The statistics reporting system of claim 29 further comprising:
a first communication bus for interfacing said device driver process and said statistics reporting process; and
a second communication bus for interfacing said I/O controller and said statistics reporting process.
